(19) United States
(12) Patent Application Publication
(10) Pub. No.: US 2013/0325800 A1
(43) Pub. Date: Dec. 5, 2013

(54) FILE MIGRATION IN A NETWORK FILE SYSTEM

(71) Applicant: Tonian Inc., Natania (IL)

(72) Inventors: Ben Zion HALEVY, Tel-Aviv (IL); Amit GOLANDER, Tel-Aviv (IL)

(73) Assignee: Tonian Inc., Natania (IL)

(21) Appl. No.: 13/900,566

(22) Filed: May 23, 2013

Related U.S. Application Data
(60) Provisional application No. 61/654,885, filed on Jun. 3, 2012.

(51) Int. Cl. G06F 17/30

(52) U.S. Cl. CPC G06F 17/30203
USPC 707/620

(57) ABSTRACT

A computerized method for managing file migration in one or more storage devices. The method comprises separately categorizing a plurality of segments of a file stored in a pNFS storage according to at least one control data request received from at least one client in real time, receiving a request to migrate the file from at least one source storage location of the pNFS storage to at least one destination storage location of the pNFS storage, separately copying a plurality of different subsets of the file to the at least one destination storage location in a plurality of separate instances where in each the instance a respective the subset selected according to a respective the categorization, and deleting the file from the at least one source storage location.

### RELATED APPLICATION

This application claims the benefit of priority under 35 USC 119(e) of U.S. Provisional Patent Application No. 61/654,885 filed Jun. 3, 2012, the contents of which are incorporated herein by reference in their entirety.

### BACKGROUND

The present invention, in some embodiments thereof, relates to file migration and, more particularly, but not exclusively, to file migration in storage devices having a concurrent retrieval configuration.

During the last years, the storage input and/or output (I/O) bandwidth requirements of clients have been rapidly outstripping the ability of network file servers to supply them. This problem is being encountered in installations running according to network file system (NFS) protocol. In order to overcome this problem, parallel NFS (pNFS) has been developed. pNFS allows clients to access storage devices directly and in parallel. The pNFS architecture increases scalability and performance compared to former NFS architectures. This increment is achieved by the separation of data and metadata and using a metadata server out of the data path.

In use, a pNFS client initiates data control requests on the metadata server, and subsequently and simultaneously invokes multiple data access requests on the cluster of data servers. Unlike in a conventional NFS environment, in which the data control requests and the data access requests are handled by a single NFS storage server, the pNFS configuration supports as many data servers as necessary to serve client requests. Thus, the pNFS configuration can be used to greatly enhance the scalability of a conventional NFS storage system. The protocol specifications for the pNFS can be found at itef.org, see NFS4.1 standards and Requests For Comments (RFC) 5661-5664 which include features retained from the base protocol and protocol extensions. Major extensions such as sessions, and directory delegations, external data representation standard (XDR) description, a specification of a block based layout type definition to be used with the NFSv4.1 protocol, and an object based layout type definition to be used with the NFSv4.1 protocol.

According to some embodiment of the present invention there is provided, a computerized method for managing file migration in one or more storage devices of a parallel access network file system. The method comprises separately categorizing a plurality of storage segments of a file stored in at least one storage device according to at least one control data request received from at least one client, receiving a request to migrate the file from at least one source storage location of the at least one storage device to at least one destination storage location of the at least one storage device, separately copying a plurality of different subsets of the file to the at least one destination storage location in a plurality of separate instances where in each the instance a respective the subset selected according to a respective the categorization, and deleting the file from the at least one source storage location.

Optionally, the computerized method is implemented by a metadata server of a pNFS protocol storage system.

Optionally, the at least one respective control data request comprises at least one layout get command.

Optionally, the separately copying is performed so that the copying of at least one portion of the plurality of segments is postpone until a recategorizing of at least one of the plurality of segments.

Optionally, the separately copying comprises sending at least one recall message to recall a part of a storage segment requested by a single control data request of the at least one control data request.

Optionally, the separately copying comprises adjusting a size of at least one of the plurality of different subsets so as to delay copying at least one of the plurality of segments until a recategorizing thereof.

Optionally, the separately copying comprises separately copying the plurality of different subsets in an inconsecutive order.

Optionally, the categorizing is set according to a write permission of the at least one respective control data request.

Optionally, the computerized method is implemented by a metadata server of a pNFS protocol storage system.

Optionally, the computerized method further comprises marking at least some of the plurality of subsets with a plurality of tags to indicate a current copying status of each the subset, receiving at least one new data control request during the separately copying, determining whether to acquire data from each the subset for responding to the at least one new data control request from the at least one source storage location or from the at least one destination storage location according to respective the plurality of tags, and responding to the at least one new data control request with the data while the file is migrated.

According to some embodiment of the present invention there is provided, a metadata server of a parallel access network file system. The server comprises a categorizing module which separately categorizes a plurality of segments of a file stored in at least one storage device according to at least one control data request received from at least one client in real time, a client interface which receives a request to migrate the file from at least one source storage location of the at least one storage device to at least one destination storage location of the at least one storage device, and a migrating module which separately copies a plurality of different subsets of the file to the at least one destination storage location in a plurality of separate instances where in each the instance a respective the subset selected according to a respective the categorization and deletes the file from the at least one source storage location.

Optionally, the at least one storage device comprises at least one pNFS data server.

According to some embodiment of the present invention there is provided, a computerized method for managing file migration in one or more storage devices of a parallel access network file system. The method comprises migrating a plurality of subsets of a file stored in at least one storage device from at least one source storage location of the at least one storage device to at least one destination storage location of the at least one storage device in a plurality of separate instances, marking at least some of the plurality of subsets with a plurality of tags to indicate a current copying status of each the subset, receiving at least one data control request during the migrating, determining whether to acquire data from each the subset for responding to the at least one data control request from the at least one source storage location or from the at least one destination storage location according to respective the plurality of tags, and responding to the at least one data control request with the data while the file is migrated.

Optionally, the determining is performed according to the size of the subset.

Optionally, the responding comprises acquiring the data in a plurality of instances where in each the instance a different portion of the data is acquired according to the determining

Optionally, the at least one respective control data request comprises at least one layout get command.

Optionally, determining depends on whether the at least one data control request having a write permission.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a storage system, such as a pNFS storage system, according to some embodiments of the present invention;

FIG. 2 is a flowchart of a method for migrating a file from one or more source storage locations and destination storage locations while preserving a high degree of concurrent retrieval of data, according to some embodiments of the present invention;

FIG. 3 is a schematic illustration depicting a state of segments of a file in a storage source location before any migration action was taken according to some embodiments of the present invention;

FIG. 4 is a schematic illustration of a state machine for selecting different subsets of the requested to-be-migrated file, according to some embodiments of the present invention;

FIG. 5 is a schematic illustration depicting a state of segments of a file in a storage source location during a file migration according to some embodiments of the present invention; and

FIG. 6 is a flowchart of a process for handing layout get requests received during a migration process according to some embodiments of the present invention.

### DETAILED DESCRIPTION

The present invention, in some embodiments thereof, relates to file migration and, more particularly, but not exclusively, to file migration in storage devices having a concurrent retrieval configuration.

According to some embodiments of the present invention, there are provided methods and systems of migrating a file in a concurrent retrieval configuration system, such as a pNFS storage system, by separately copying a plurality of subsets of the file in a plurality of separate instances while taking into account which segments of the file are currently accessed by control data requests, such as layout get commands. The subsets are optionally set according to the write permissions of the control data requests. The size of the subsets is optionally adapted to the segments of the file so that the content of these segments is copied in subsequent instance after a respective control data request session is finalized. Optionally, subsets are copied in a nonconsecutive manner, facilitating, as much as possible, a continuous data migration while control data requests are treated.

According to some embodiments of the present invention, there are provided methods and systems of serving control data requests, such as layout get commands, during a file migration process. In these embodiments, some segments of data requested by layout get commands are acquired from source storage location(s) while other segments are acquired from destination storage location(s). The acquisition is determined according to a copying status that is given to segments during the migration process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

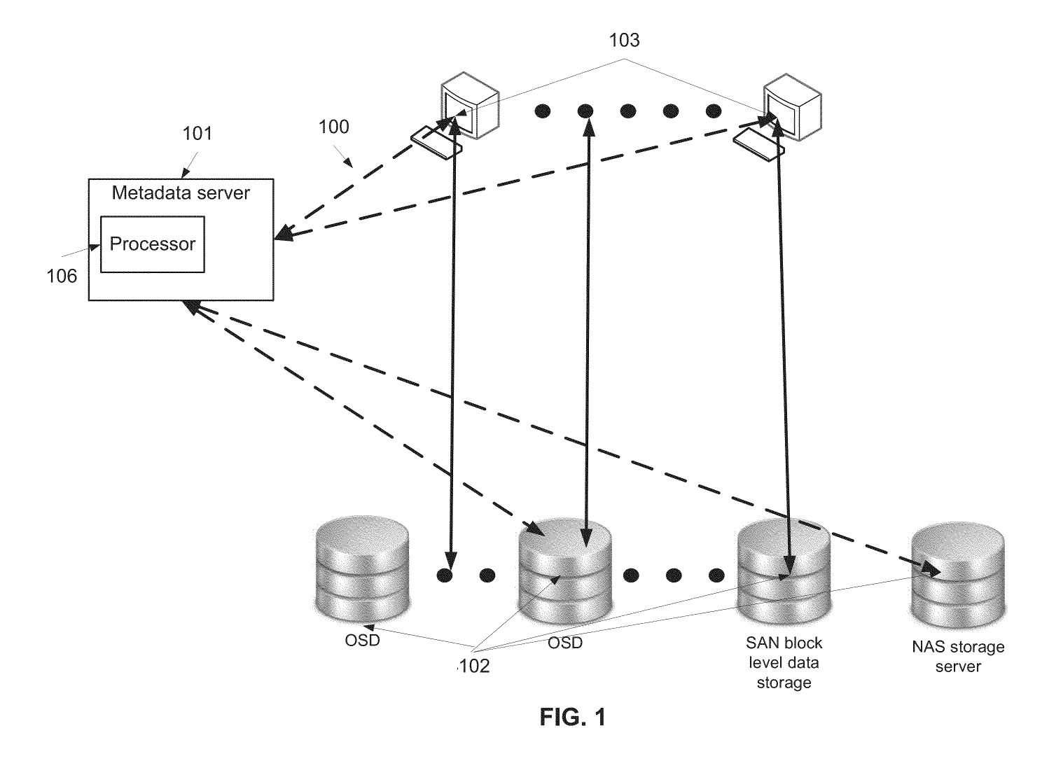

Reference is now made to FIG. 1, which is a schematic illustration of a storage system 100, optionally a concurrent retrieval configuration system 100, such as a pNFS storage system, that includes metadata server 101 and a plurality of storage devices (also known in pNFS as data servers) 102 which provide storage services to a plurality of concurrent retrieval clients 103, according to some embodiments of the present invention. Optionally, the storage system 100 provides concurrent retrieval access to subsets of files stored in the storage devices 102, for example according to a protocol such as pNFS protocol.

Optionally, the metadata server 101 and one or more of the storage devices 102, for example storage servers, are hosted on a common host. According to some embodiments of the present invention, a number of metadata servers 101 are used. In such an embodiment, the metadata servers 101 are coordinated, for example using a node coordination protocol. For brevity, a number of metadata servers 101 are referred to herein as a metadata server 101.

A client 103, which is optionally a pNFS client 103 capable of communicating according to pNFS protocol, may be, for example, a conventional personal computer (PC), a server-class computer, a laptop, a tablet, a workstation, a handheld computing or communication device, a hypervisor and/or the like. A storage device 102 is optionally an object storage device (OSD), for example a server, such as a file-level server, for example, a file-level server used in network attached storage (NAS) environment or a block-level storage server such as a server used in a storage area network (SAN) environment. The storage device 102 can include, for example, conventional magnetic or optical disks or tape drives; alternatively, they can include non-volatile solid-state memory, such as flash memory, or be a gateway to storage available on a cloud, such as Amazon S3 and/or the like.

Optionally, pNFS configuration is implemented to allow concurrent retrieval of subsets of files stored in the pNFS storage system 100. In this pNFS configuration, the plurality of storage devices 102 simultaneously respond to multiple data requests from the clients 103. In use, the storage system 100 handles data control requests, for example file lookup and open requests, and the plurality of storage devices 102 process data access requests, for example data writing and retrieving requests.

Optionally, the metadata server 101 includes one or more processors 106, referred to herein as a processor, memory, communication device(s) (e.g., network interfaces, storage interfaces), and interconnect unit(s) (e.g., buses, peripherals), etc. The processor 106 may include central processing unit(s) (CPUs) and control the operation of the system 100. In certain embodiments, the processor 106 accomplishes this by executing software or firmware stored in the memory. The processor 106 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

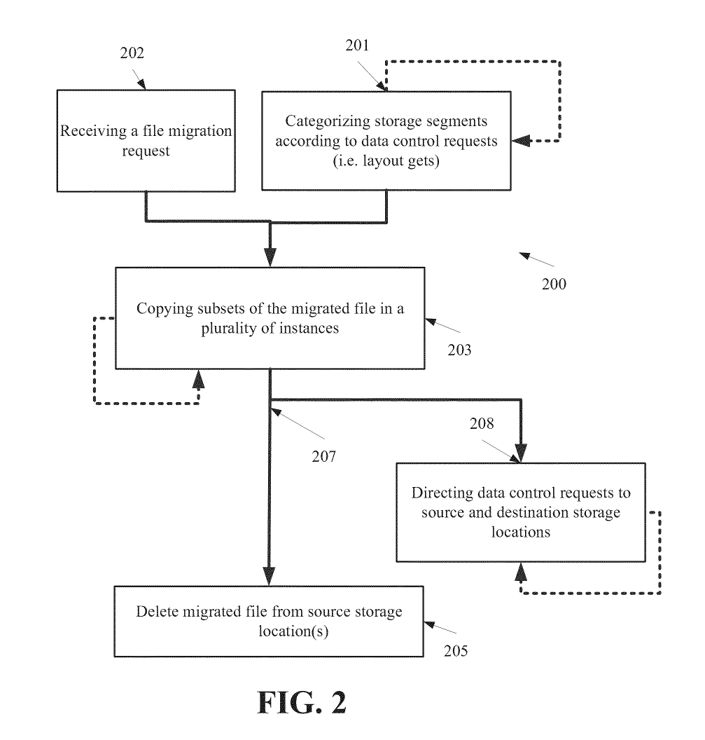

Reference is now also made to FIG. 2, which is a flowchart of a method 200 for migrating a file from one or more source storage locations and destination storage locations while preserving a high degree of concurrent retrieval of data, according to some embodiments of the present invention. The process depicted in FIG. 2 is optionally managed by the metadata server 101.

Common methods of data migration are disruptive to clients, such as 103, as they are based on delaying access to a file until all of its segments not associated with a certain client are returned.

As shown at 201, during the implementation of the method 200 segments of each file stored in the storage system 100 are categorized according to respective control data requests which are received from one or more client(s) 103. The categorizing optionally defines location segment permissions. Optionally, segments are categorized according to the permissions of the control data requests. For example, a location segment requested by a control data request with write permission is categorized as no-access location segment and a location segment requested by another control data request with a read only permission is categorized as full access location segment.

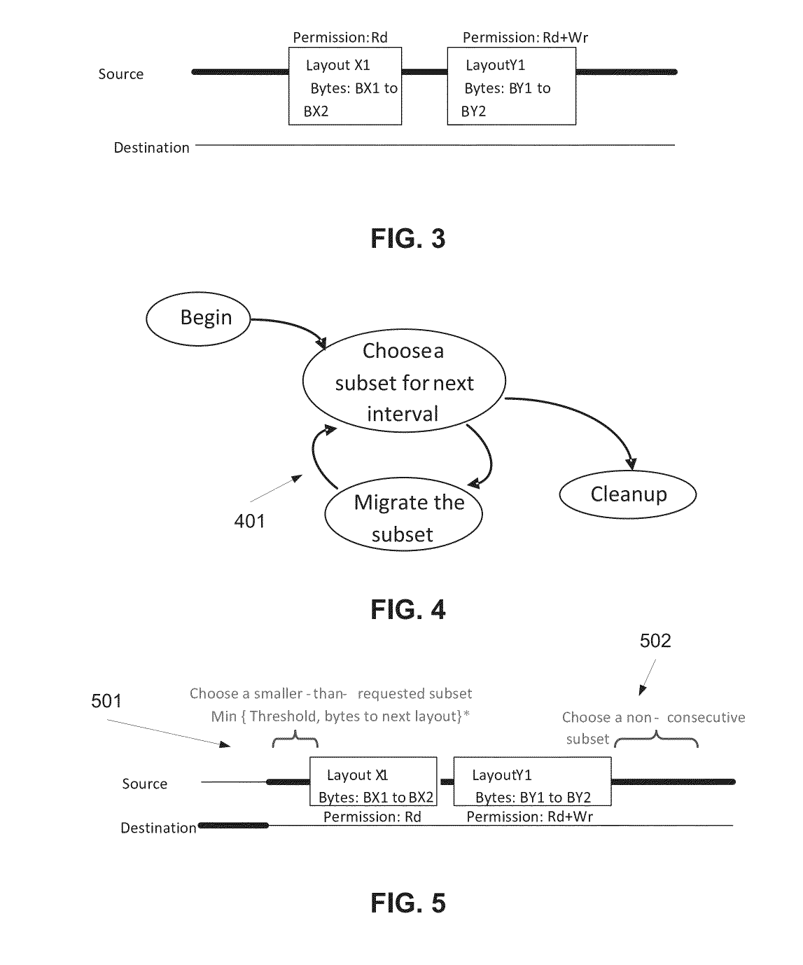

In such embodiments, when a request to migrate a file from one or more source storage locations of the storage system 100 to one or more destination storage locations of the storage system 100, is received, for example as shown at 202, the source storage locations are categorized according to outstanding control data requests. For example, FIG. 3 is a schematic illustration depicting a state of segments of a file in a storage source location before any migration action was taken, excluding an allocation of one or more destination storage locations. The entire file is at the source and there are two segments which are addressed by two outstanding control data requests, such as layout get requests.

After the request to migrate the file is received, as shown at 203, a plurality of different subsets of the requested file are copied to the one or more destination storage locations in a plurality of separate instances where in each instance, a respective subset is selected according to a respective categorization. In such a manner, the copying of a portion of the file may be postponed while another portion is being copied.

For example, reference is now made to FIG. 4, which is a schematic illustration of a state machine for selecting different subsets of the requested file, according to some embodiments of the present invention. As shown at 401, subsets are selected and migrated as long as not all segments of the file are copied. In each instance, a subset may be selected in various manners. For example, the first subset is selected from the first byte and proceeds towards the end. For each instance, for example sequential interval, a storage portion that has predefined size is selected as a subset to be copied. If a storage portion includes at least a part of a no-access location segment, the a smaller-than-requested subset may be selected, for example a subset that includes bytes between the last byte of the last subset which has been copied and the first byte of a no-access location segment set according to a layout, for example as shown by numeral 501 in FIG. 5. Optionally, the size of any subset must comply with a predefined minimum size. Additionally or alternatively, when a potential subsequent subset includes no-access location segment(s), a non consecutive subset may be selected for example as shown at numeral 502 in FIG. 5. Optionally, segments requested by read only layout(s) are not set as no-access segments.

Optionally, a recall message is sent to release storage segments which are categorized as no-access storage segment. Optionally other subsets are copied while waiting for a reply notice, such as ack+layout return or no matching layout response. The recall message may be to release only part of the storage segment claimed by a pending layout get request. In such embodiments, the request is actually to resize the layout get request. For example, CB_LAYOUTRECALL request for bytes X₁-X_{n-y} from X₁-Xₙ segment is sent. Optionally, recall messages may be send to release only the storage segment claimed by a pending layout get request with write permissions.

During a migration of a subset, new layout get requests may be denied for to this particular subset. Optionally the denied layout get requests are layout get requests with write permissions. It should be noted that thought reference is made to layout get requests other data control requests may be handled similarly.

Optionally, during a migration of a subset, new layout get requests to a particular subset are denied or delayed. Segments set as no-access segments, for example as an outcome of outstanding layout get requests with write permissions, are reclaimed, optionally periodically until the file migration is completed. Optionally, after a subset is copied from a source storage location to a destination storage location, it is marked as copied. Optionally, new layout get requests may be directed to acquire migrated data just after the migrated data has been passed.

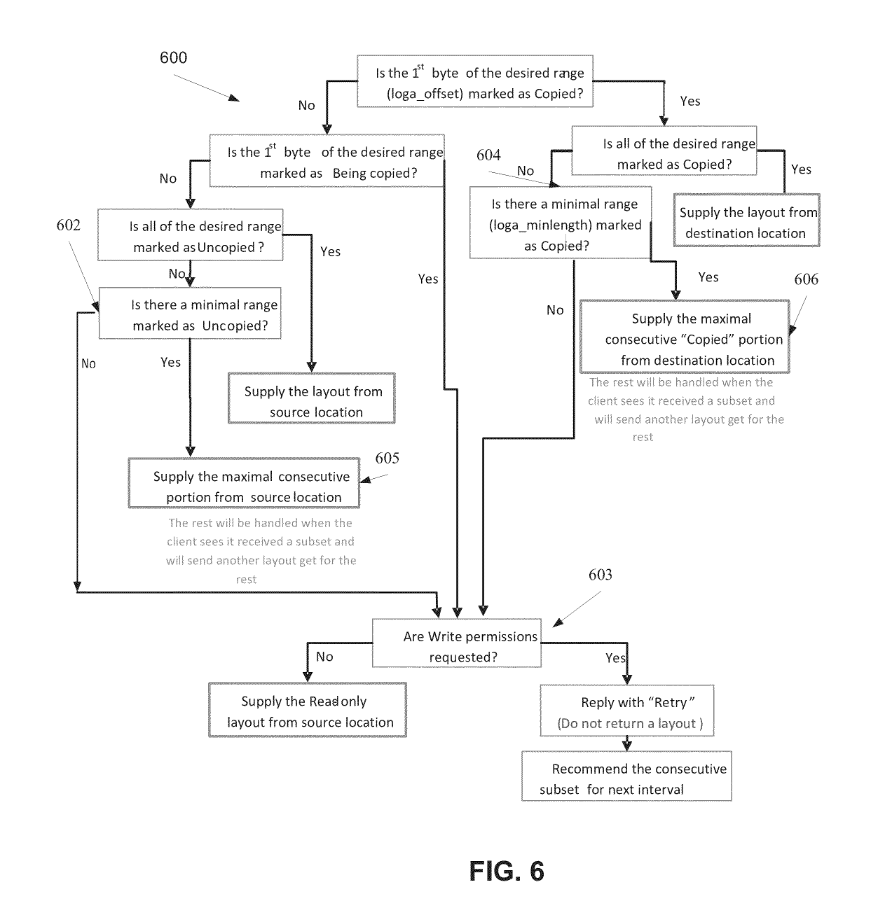

For instance, during the migration, each subset is marked with a tag indicative of a current status, for example copied or being copied where untagged subsets are uncopied. In such a manner, all or some of the control data requests, which are received during the migrating process, may be handled without delay, for example as depicted in FIG. 6 and described below.

As shown at 201 and 207, the categorizations and the subset copying are performed iteratively so that subsets which have not been copied in one instance may be copied in proceeding instance, when respective segments are re-categorized.

During the migration process, as shown at 208, data control requests, such as layout get requests, are being served by the metadata server 101 without delay. The data control requests for accessing un-copied segments are optionally directed to the source storage location(s) and data control requests for accessing copied segments are optionally directed to the destination storage location(s). For example, reference is now made to FIG. 6, which is a flowchart 600 of a process for handing layout get requests received during a migration process, according to some embodiments of the present invention. As depicted in flowchart 600, un-copied segments may be acquired from the source storage locations and copied segments may be acquired from the destination storage locations. Optionally, for example as shown at 602 and 604, the consecutive storage area of the location segment from the response to the layout get request is checked. If this consecutive storage area is larger than a predefined area, it is served in a number of separate instances where in each instance no more than a maximal amount is served, see 605, 606. If this consecutive storage area is below a predefined area, another subset may be provided, optionally based on the write permissions of the layout get request, for example see 603. Optionally, if the layout get has read only permission, all the data maybe acquired from the source storage locations. Optionally, if the layout get has write permission, it is served from copied data in the destination storage locations. In this process, data may be acquired in a plurality of instances.

As shown at 205, after the all the subsets are migrated, the respective file is deleted from the source storage location(s). Optionally, at this stage, layout get request pointing to the source storage location are reclaimed. Optionally, step 205 is delayed to provide clients a chance to return the layouts at their convenient time.

It should be noted that the method described in FIG. 2 allows migrating files in sequential or concurrent intervals. In such a manner, the time required for migrating a file may be reduced by parallel copying.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, location segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a metadata server, a pNFS system, and a storage device is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for managing file migration in one or more storage devices of a parallel access network file system, comprising:
separately categorizing a plurality of storage segments of a file stored in at least one storage device according to at least one control data request received from at least one client;
receiving a request to migrate said file from at least one source storage location of said at least one storage device to at least one destination storage location of said at least one storage device;
separately copying a plurality of different subsets of said file to said at least one destination storage location in a plurality of separate instances where in each said instance a respective said subset selected according to a respective said categorization; and
deleting said file from said at least one source storage location.

2. The method of claim 1, wherein said computerized method is implemented by a metadata server of a pNFS protocol storage system.

3. The method of claim 1, wherein said at least one respective control data request comprises at least one layout get command.

4. The method of claim 1, wherein said separately copying is performed so that the copying of at least one portion of said plurality of segments is postpone until a recategorizing of at least one of said plurality of segments.

5. The method of claim 1, wherein said separately copying comprises sending at least one recall message to recall a part of a storage segment requested by a single control data request of said at least one control data request.

6. The method of claim 1, wherein said separately copying comprises adjusting a size of at least one of said plurality of different subsets so as to delay copying at least one of said plurality of segments until a recategorizing thereof.

7. The method of claim 1, wherein said separately copying comprises separately copying said plurality of different subsets in an inconsecutive order.

8. The method of claim 1, wherein said categorizing is set according to a write permission of said at least one respective control data request.

9. A computer readable medium comprising computer executable instructions adapted to perform the method of claim 1.

10. The method of claim 1, wherein said computerized method is implemented by a metadata server of a pNFS protocol storage system.

11. The method of claim 1, further comprising:
marking at least some of said plurality of subsets with a plurality of tags to indicate a current copying status of each said subset;
receiving at least one new data control request during said separately copying;
determining whether to acquire data from each said subset for responding to said at least one new data control request from said at least one source storage location or from said at least one destination storage location according to respective said plurality of tags; and
responding to said at least one new data control request with said data while said file is migrated.

12. A metadata server of a parallel access network file system, comprising:
a categorizing module which separately categorizes a plurality of segments of a file stored in at least one storage device according to at least one control data request received from at least one client in real time;
a client interface which receives a request to migrate said file from at least one source storage location of said at least one storage device to at least one destination storage location of said at least one storage device; and
a migrating module which separately copies a plurality of different subsets of said file to said at least one destination storage location in a plurality of separate instances where in each said instance a respective said subset selected according to a respective said categorization and deletes said file from said at least one source storage location.

13. The metadata server of claim 12, wherein said at least one storage device comprises at least one pNFS data server.

14. A computerized method for managing file migration in one or more storage devices of a parallel access network file system, comprising:
migrating a plurality of subsets of a file stored in at least one storage device from at least one source storage location of said at least one storage device to at least one destination storage location of said at least one storage device in a plurality of separate instances;
marking at least some of said plurality of subsets with a plurality of tags to indicate a current copying status of each said subset;
receiving at least one data control request during said migrating;
determining whether to acquire data from each said subset for responding to said at least one data control request from said at least one source storage location or from said at least one destination storage location according to respective said plurality of tags; and
responding to said at least one data control request with said data while said file is migrated.

15. The method of claim 14, wherein said determining is performed according to the size of said subset.

16. The method of claim 14, wherein said responding comprises acquiring said data in a plurality of instances where in each said instance a different portion of said data is acquired according to said determining

17. The method of claim 14, wherein said at least one respective control data request comprises at least one layout get command.

18. The method of claim 14, wherein determining depends on whether said at least one data control request having a write permission.

19. A computer readable medium comprising computer executable instructions adapted to perform the method of claim 12.
